(19) United States
(12) Patent Application Publication
(10) Pub. No.: US 2016/0065089 A1
(43) Pub. Date: Mar. 3, 2016

(54) THREE-PHASE CURRENT CONVERTER WITH VARIED INDUCTANCES AND THREE-PHASE D-SIGMA CONTROL METHOD THEREOF

(71) Applicant: National Tsing Hua University, Hsinchu City (TW)

(72) Inventors: Tsai-Fu Wu, Hsinchu City (TW); Chih-Hao Chang, Hsinchu City (TW); Li-Chiun Lin, Hsinchu City (TW); Yung-Ruei Chang, Hsinchu City (TW)

(21) Appl. No.: 14/525,224

(22) Filed: Oct. 28, 2014

(30) Foreign Application Priority Data
Aug. 29, 2014 (TW) 103129886

(51) Int. Cl. H02M 7/5387

(52) U.S. Cl. CPC H02M 7/53873

(57) ABSTRACT

A three-phase current converter and a three-phase D-Σ control method with varied inductances are provided. In this method, two current variations of a first phase current, a second phase current and a third phase current flowing through a first inductor, a second inductor and a third inductor of the three-phase current converter respectively and two phase voltages of a first phase voltage, a second phase voltage and a third phase voltage are obtained. A first calculation is executed according to inductances of the inductors, the current variations and a switching period of a vector space modulation to obtain a calculation result. A second calculation is executed according to the phase voltages and the calculation result to obtain a duty ratio of the switching period of switch sets of the three-phase current converter. The inductances vary with the phase currents respectively.

### CROSS-REFERENCE TO RELATED APPLICATION

This application claims the priority benefit of Taiwan application serial no. 103129886, filed on Aug. 29, 2014. The entirety of the above-mentioned patent application is hereby incorporated by reference herein and made a part of this specification.

### BACKGROUND

1. Field of the Invention

The invention is related to a control technique for power conversion and more particularly, to a three-phase current converter apparatus with varied inductances and a three-phase division-summation (D-Σ) control method thereof.

2. Description of Related Art

Among green energy, solar energy is an inexhaustible energy. Techniques related to the solar energy is growingly developed. When the solar energy is obtained by a solar power-generation apparatus (e.g., a solar panel) and then converted into electricity. The electricity can be directly incorporated into a local distribution network or stored in batteries. However, the batteries relatively cost high due to limited lifespan thereof. In case an inverter is used, if the solar energy is directly incorporated into the local distribution network through the inverter, power consumption during transmission can be reduced, as well as power loss can be lowered down, which leads to higher efficiency of the power-generation system. Besides, the inverter can be designed to be capable of a bi-directional inverting function, such that the solar energy can be provided to a DC load, without being converted into DC after being incorporated into the local distribution network. In this way, power consumption can be further saved for about 8%. In terms of selection of a bi-directional inverter, a three-phase inverter is the main selection for a system with more than 10 kW to meet requirements for power supply and system expandability in the further. In other words, control and reliability of a three-phase current converter are major subjects of future researches.

Specifically, the three-phase current converter may have circuit structures as illustrated in FIG. 1A and FIG. 1B. FIG. 1A and FIG. 1B respectively illustrate three-phase current converters of two types of AC circuits configured in Δ-Δ connection and Y-Δ connection, and respectively include switch sets S1 to S6 configured in a full-bridge manner, a DC terminal VDC coupled to switch sets S1 to S6, three phase power supply terminals R, S, T and inductors LR, LS, LT respectively corresponding to the three phase power supply terminals R, S, T. Phase currents IR, IS, IT respectively flow through the inductors LR, LS, LT, v_{RS}, v_{ST}, v_{TR} are phase voltages, and u_{R}, u_{S}, U_{T} are endpoint potentials.

According to the aforementioned circuit structures, a conventional three-phase control method is mainly subject to a current controller developed based on a space vector pulse width modulation (SVPWM) technique. First, a state equation of a three-phase system is established and then converted into a two-dimensional equation through a dq axis (which includes a direct axis and a quadrature axis) conversion matrix, and a time for converting into each vector according to a voltage reference instruction, such that a PWM signal can be output to drive the inverter. It should be mentioned that the aforementioned conversion method is only adapted for a scenario with balanced three-phase voltage without distortion, and therefore, the distortion resulted from city power harmonic and three-Phase imbalance has to be corrected by utilizing current error compensation. In addition, a dual-buck control method is provided to simplify the complex derivation by means of the dq axis conversion; however, the derivation process is successful only when a condition that inductances of the three-phase system are identical is satisfied.

Nevertheless, the inductances of the three-phase system are not constant. According to FIG. 2, a graph illustrating that the inductances vary with the currents, as the system has greater power, the inductances become less while the currents are increased. If the inductance variations are not considered for the controller, the insufficiency of each inductance has to be corrected by using a great amount of compensation, which causes risks of oscillation or even divergence to the system.

### SUMMARY

Accordingly, the invention provides a three-phase current converter apparatus with varied inductances and a three-phase division-summation (D-Σ) control method thereof capable of avoid city power harmonic from being distorted and simplifying a conversion process thereof.

The invention is directed to a three-phase D-Σ control method of a three-phase current converter with varied inductances. The three-phase current converter has a first inductor, a second inductor and a third inductor, and a first phase current, a second phase current and a third phase current respectively flow through the first inductor, the second inductor and the third inductor. The three-phase D-Σ control method includes obtaining two of a plurality of current variations of the first phase current, the second phase current and the third phase current and two of a plurality of phase voltages of a first phase voltage, a second phase voltage and a third phase voltage; executing a first calculation according to a plurality of inductances of the inductors, the current variations and a switching period of a vector space modulation to obtain a calculation result; and executing a second calculation according to the phase voltages and the calculation result to obtain a duty ratio of the switching period of the vector space modulation of a plurality of switch sets of the three-phase current converter. The inductances respectively vary with the first phase current, the second phase current and the third phase current.

In an embodiment of the invention, the step of executing the first calculation according to the plurality of inductances of the inductors, the current variations and the switching period of the vector space modulation to obtain the calculation result further includes calculating a plurality of cross voltages on the inductors by using the inductances and the current variations in a matrix manner to obtain a first matrix; and calculating a product by multiplying the reciprocal of the switching period with the first matrix to obtain the calculation result.

In an embodiment of the invention, the method further includes: dividing the vector space into a plurality of intervals according to intersections of the first phase voltage, the second phase voltage and the third phase voltage of the three-phase current converter respectively intersecting with zero voltage, where each of the intervals is defined by two non-zero vectors and zero vector.

In an embodiment of the invention, the step of executing the second calculation according to the phase voltages and the calculation result to obtain the duty ratio of the switching period of the vector space modulation of the plurality of switch sets of the three-phase current converter further includes: obtaining a plurality of state-switching voltages corresponding to one of the intervals in the vector space to obtain a second matrix; calculating a sum of the phase voltages and the calculation result to obtain a third matrix; and calculating a product by multiplying the inverse matrix of the second matrix with the third matrix to obtain the duty ratio of the switching period of the vector space modulation of the switch sets.

In an embodiment of the invention, a relation of the inductances varying with the first phase current, the second phase current and the third phase current is recorded in a loop-up table, and the step of executing the first calculation according to the plurality of inductances of the inductors, the current variations and the switching period of the vector space modulation further includes respectively obtaining the plurality of inductances by using the loop-up table according to the first phase current, the second phase current and the third phase current.

In an embodiment of the invention, each of the current variations is a difference between a reference current and a detected current of the switching period.

The invention is directed to a three-phase current converter apparatus with varied inductances, including a three-phase current converter, a driver circuit and a controller. The three-phase current converter has a first inductor, a second inductor and a third inductor. A first phase current, a second phase current and a third phase current respectively flow through the first inductor, the second inductor and the third inductor. The driver circuit is coupled to the three-phase current converter to drive the three-phase current converter. The controller is coupled to the driver circuit to obtain two of a plurality of current variations of the first phase current, the second phase current and the third phase current and two of a plurality of phase voltages of a first phase voltage, a second phase voltage and a third phase voltage and configured to execute a first calculation according to a plurality of inductances of the inductors, the current variations and a switching period of a vector space modulation to obtain a calculation result and execute a second calculation according to the phase voltages and the calculation result to obtain a duty ratio of the switching period of the vector space modulation of a plurality of switch sets of the three-phase current converter. The inductances respectively vary with the first phase current, the second phase current and the third phase current.

To sum up, in the three-phase current converter apparatus with varied inductances and the three-phase D-Σ control method thereof provided by the embodiments of the invention, the currents of the three-phase system are converted by using the state-switching voltages of the vector space with modulated pulses, so as to obtain the duty ratio of the switching period of the vector space modulation of a plurality of switch sets in the three-phase current converter. Thereby, the three-phase current converter apparatus and the control method can be adapted for scenarios where variations occur to the inductors to prevent the city power from being distorted and to simplify the conversion process.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic diagram illustrating a conventional three-phase current converter configured in Δ-Δ connection.

FIG. 1B is a schematic diagram illustrating a three-phase current converter configured in Y-Δ connection.

FIG. 2 is a graph illustrating inductances of inductors of a three-phase system varying with currents.

FIG. 3 is a schematic diagram illustrating a three-phase current converter apparatus according to an embodiment of the invention.

FIG. 4 is a voltage waveform chart illustrating phase voltages of the three-phase system within a city power cycle according to an embodiment of the invention.

FIG. 5 illustrates a vector space distribution map according to an embodiment of the invention.

FIG. 6 is a flowchart illustrating a three-phase D-Σ control method of a three-phase current converter apparatus with varied inductances according to an embodiment of the invention.

### DESCRIPTION OF EMBODIMENTS

In order to resolve the issues that may occur during inductance variations and conversion by using the d-q axis, the embodiments of the invention provide a three-phase current converter apparatus with varied inductances and a three-phase division-summation (D-Σ) control method thereof capable of performing conversion in a three phase D-Σ means, such that inductance variations of the three-phase system are considered, and the conversion process can be simplified to fix the distortion issue occurring to the conventional power conversion during the parallel mode of the city power.

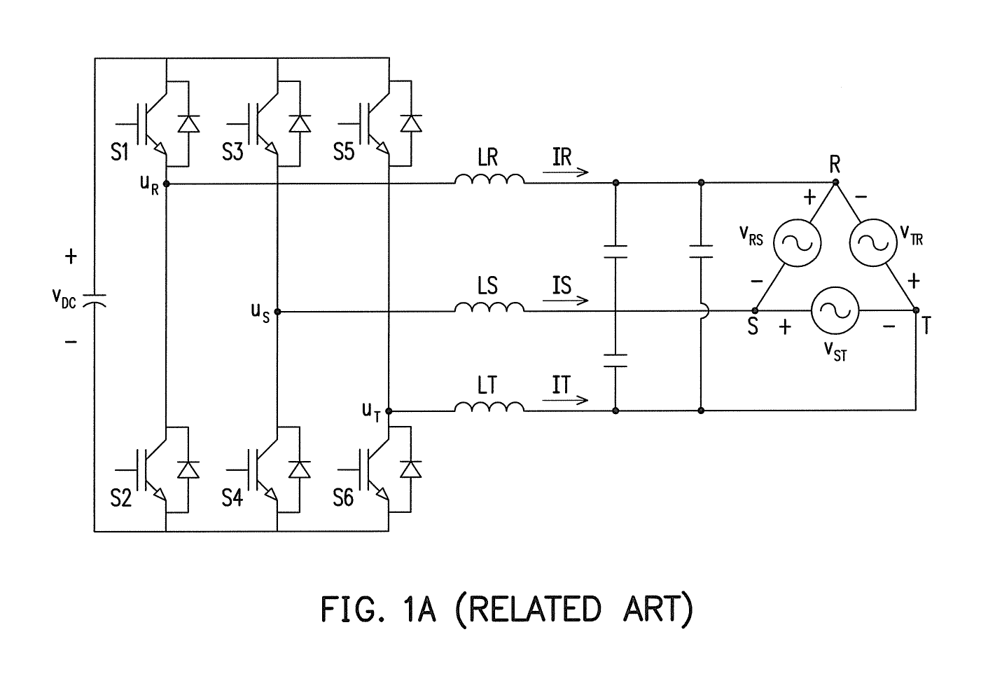

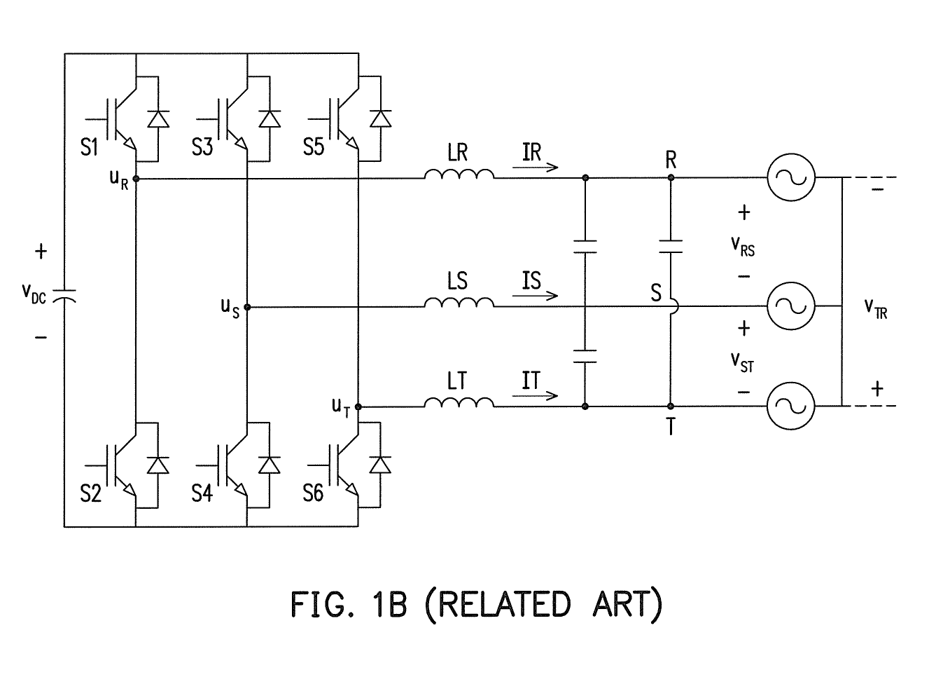

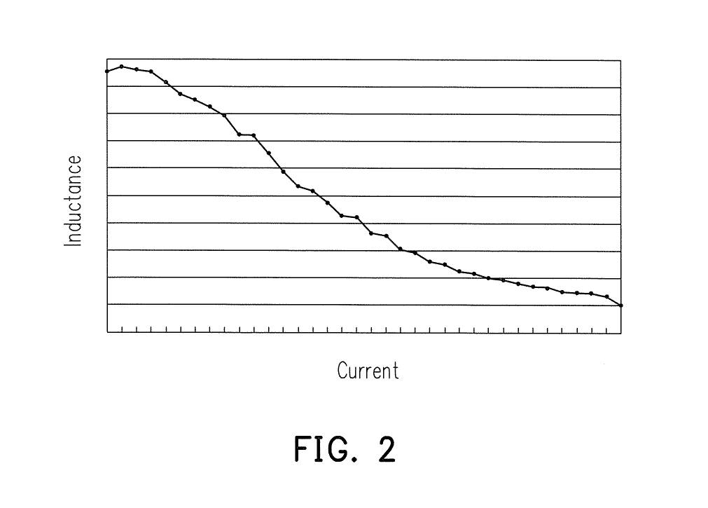

FIG. 3 is a schematic diagram illustrating a three-phase current converter apparatus according to an embodiment of the invention. A three-phase current converter apparatus 300 includes a three-phase current converter 310, a driver circuit 320 and a controller 330. The driver circuit 320 is configured to drive the three-phase current converter 310. The three-phase current converter 310 includes switch sets S1 to S6 forming a full-bridge architecture, a DC terminal VDC coupled to the switch sets S1 to S6, three phase power supply terminals R, S, T and inductors LR, LS, LT respectively corresponding to the three phase power supply terminals R, S, T. Phase currents IR, IS, IT respectively flow through the inductors LR, LS, LT. Additionally, the three phase power supply terminals R, S, T are connected with an AC circuit 312, and the AC circuit 312 may be configured, for example, in a form of one of the Δ-Δ connection shown in FIG. 1A and the Y-Δ connection shown in FIG. 1B.

The controller 330 is coupled to the driver circuit 320 and configured to obtain a duty ratio of a switching period T of a vector space modulation of the switch sets S1 to S6 of the three-phase current converter 310, so as to control the driver circuit 320 to drive the three-phase current converter 310 to switch power among the DC terminal VDC and the three phase power supply terminals R, S, Ts according to the duty ratio of the switch sets S1 to S6.

Based on the circuit structure of FIG. 3, description with respect to how to obtain the duty ratio of the switching period T of the switch sets S1 to S6 will be set forth below.

First, a loop equation for any two loops in the circuit structure of the three-phase current converter 310 may be expressed according to Kirchhoff's Voltage Law (KVL). Taking a loop formed from an endpoint A to an endpoint B and a loop formed from the endpoint B to an endpoint C for example, a relation between the loops corresponding to a matrix pattern thereof may be expressed by Equation (1):

$$[ \begin{matrix}{u}_{RS} \\ {u}_{ST}\end{matrix} ] = {L}_{2 S} [ \begin{matrix}\frac{d {i}_{R}}{d t} \\ \frac{d {i}_{S}}{d t}\end{matrix} ] + [ \begin{matrix}{v}_{RS} \\ {v}_{ST}\end{matrix} ] \qquad ( 1 )$$

Therein, u_{RS}=u_{R}−u_{S} and u_{ST}=u_{S}−U_{T} are defined, where u_{R}, u_{S}, u_{T} are respectively potentials of the endpoint A, B, C, state-switching voltages u_{RS}, u_{ST} may be determined according to a turned-on or a turned-off state of each of the switch sets S1 to S6 (which will be described in detail below), and v_{RS}, v_{ST} are phase voltages. Besides, the matrix

$${L}_{2 S} = [ \begin{matrix}{L}_{R} & - {L}_{S} \\ {L}_{T} & {L}_{S} + {L}_{T}\end{matrix} ] ,$$

and inductances L_{R}, L_{S}, L_{T} of the inductors LR, LS, LT in the Equation (1) are considered as variables, where the inductances L_{R}, L_{S}, L_{T} vary with the phase currents IR, IS, IT.

It should be noted that the relations of the inductances L_{R}, L_{S}, L_{T} varying with the phase currents IR, IS, IT may be, for example, recorded in a look-up table, and the controller 330 may further utilize the look-up table to obtain the inductances L_{R}, L_{S}, L_{T} according to the phase currents IR, IS, IT. The loop-up table is, for example, stored in a storage unit of the three-phase current converter apparatus 300, such that the controller 330 may access thereto. Alternatively, the relations of the inductances L_{R}, L_{S}, L_{T} varying with the phase currents IR, IS, IT may be established, by means of equationalization, such as a best linear approximation method.

Then, after the matrix of Equation (1) is calculated, an state equation expressing transient current variations di_{R}, di_{S} with respect to the phase currents IR, IS can be obtained, as shown in Equation (2):

$$\frac{d}{d t} [ \begin{matrix}{i}_{R} \\ {i}_{S}\end{matrix} ] = - {L}_{2 S}^{- 1} [ \begin{matrix}{v}_{RS} \\ {v}_{ST}\end{matrix} ] + {L}_{2 S}^{- 1} [ \begin{matrix}{u}_{RS} \\ {u}_{ST}\end{matrix} ] \qquad ( 2 )$$

Therein, the matrix

$${L}_{2 S}^{- 1} = \frac{1}{\vert {L}_{2 S} \vert} [ \begin{matrix}{L}_{R} & - {L}_{S} \\ {L}_{T} & {L}_{S} + {L}_{T}\end{matrix} ] ,$$

### and |L_{2S}|=L_{R}L_{S}+L_{S}L_{T}+L_{T}L_{R}.

On the other hand, one switching period T of the three-phase current converter 310 may be further divided into three time intervals T₀, Tₓ, T_{y}. However, in a digital circuit, it has some difficulty in implementing accurately sensing a transient current variation (e.g., di_{R} or di_{S}) in each of the time intervals T₀, Tₓ, T_{y}. Therefore, in the present embodiment, a state equation expressing current variations (e.g., Δi_{R}, Δi_{S}) related to the state-switching voltages can be obtained according to the superposition theorem and by utilizing the current variations within one switching period T. In detail, Equation (3) expresses relation between each of the time intervals T₀, Tₓ, T_{y} and state-switching voltages u_{RS,0}, u_{RS,x}, u_{RS,y}, u_{ST,0}, u_{ST,x}, u_{ST,y} obtained in the switching period T as follows:

$$[ \begin{matrix}{u}_{RS} \\ {u}_{ST}\end{matrix} ] T = [ \begin{matrix}{u}_{RS , 0} & {u}_{RS , x} & {u}_{RS , y} \\ {u}_{ST , 0} & {u}_{ST , x} & {u}_{ST , y}\end{matrix} ] [ \begin{matrix}{T}_{0} \\ {T}_{x} \\ {T}_{y}\end{matrix} ] \qquad ( 3 )$$

Equation (3) is a D-Σ conversion equation. On the basis that both the state-switching voltages u_{RS,0} and u_{ST,0} are 0 in any time, Equation (3) is further simplified to obtain the simplified D-Σ conversion equation as follows:

$$[ \begin{matrix}{u}_{RS} \\ {u}_{ST}\end{matrix} ] T = [ \begin{matrix}{u}_{RS , x} & {u}_{RS , y} \\ {u}_{ST , x} & {u}_{ST , y}\end{matrix} ] [ \begin{matrix}{T}_{x} \\ {T}_{y}\end{matrix} ] \qquad ( 4 )$$

Then, the result of Equation (4) is substituted back to Equation (2) and after the matrix calculation, Equation (5) can be obtained, which is as follows:

$$[ \begin{matrix}{D}_{x} \\ {D}_{y}\end{matrix} ] = {[ \begin{matrix}{u}_{RS , x} & {u}_{RS , y} \\ {u}_{ST , x} & {u}_{ST , y}\end{matrix} ]}^{- 1} \{ \frac{1}{T} {L}_{2 S} [ \begin{matrix}Δ {i}_{R} \\ Δ {i}_{S}\end{matrix} ] + [ \begin{matrix}{v}_{RS} \\ {v}_{ST}\end{matrix} ] \} \qquad ( 5 )$$

Therein,

$${D}_{x} = \frac{{T}_{x}}{T} , {D}_{y} = \frac{{T}_{y}}{T} ,$$

and Dₓ, D_{y} represent a duty ratio corresponding to vectors Vx, Vy in a vector space of the switching period T. Additionally, each of the current variations Δi_{R}, Δi_{S} may be a difference between a reference current I_{ref} and a detected current I_{fb} within a single switching period T. Therein, the reference current I_{ref} may be a pre-set value, and the detected current I_{fb} may be one of the phase currents IR, IS, IT, which is detected through, for example, a detecting circuit 340. The techniques for setting the reference current I_{ref} and obtaining the detected current I_{fb} should be common to the persons of skill in the art, and thus, details thereabout will no longer described. Meanwhile, the detecting circuit 340 is configured to detect not only the phase currents IR, IS, IT, but also a voltage v_{DC} of the DC terminal VDC and the phase voltages v_{RS}, v_{ST}, v_{TR}, but the invention is not limited thereto.

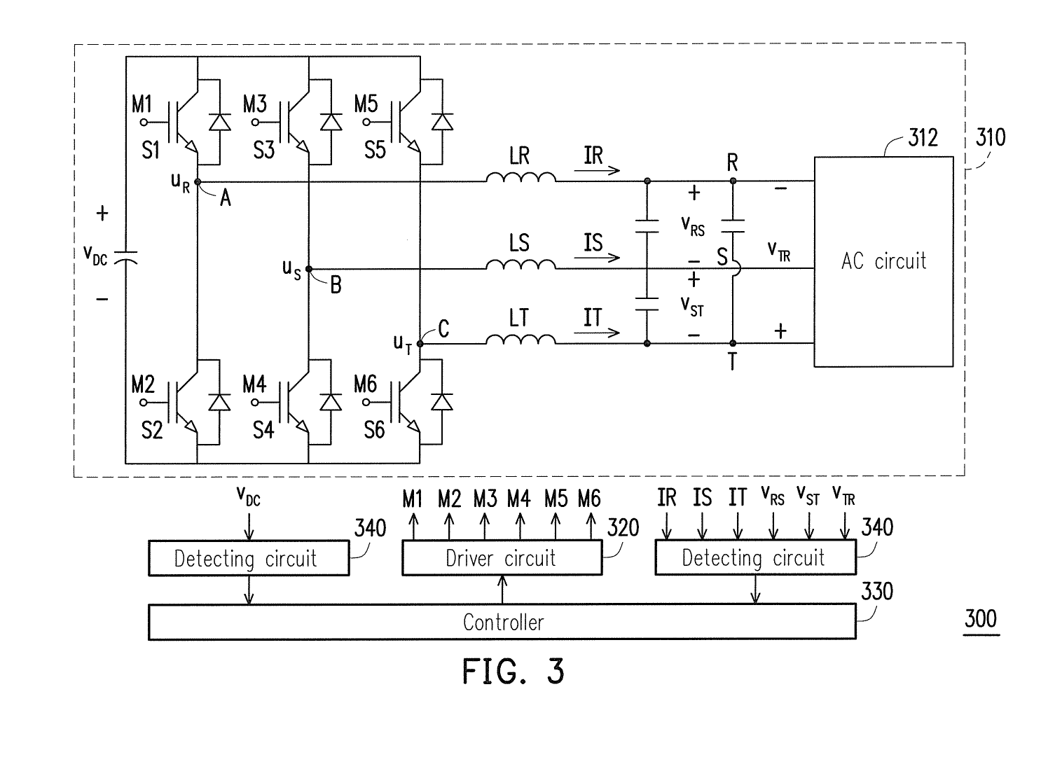

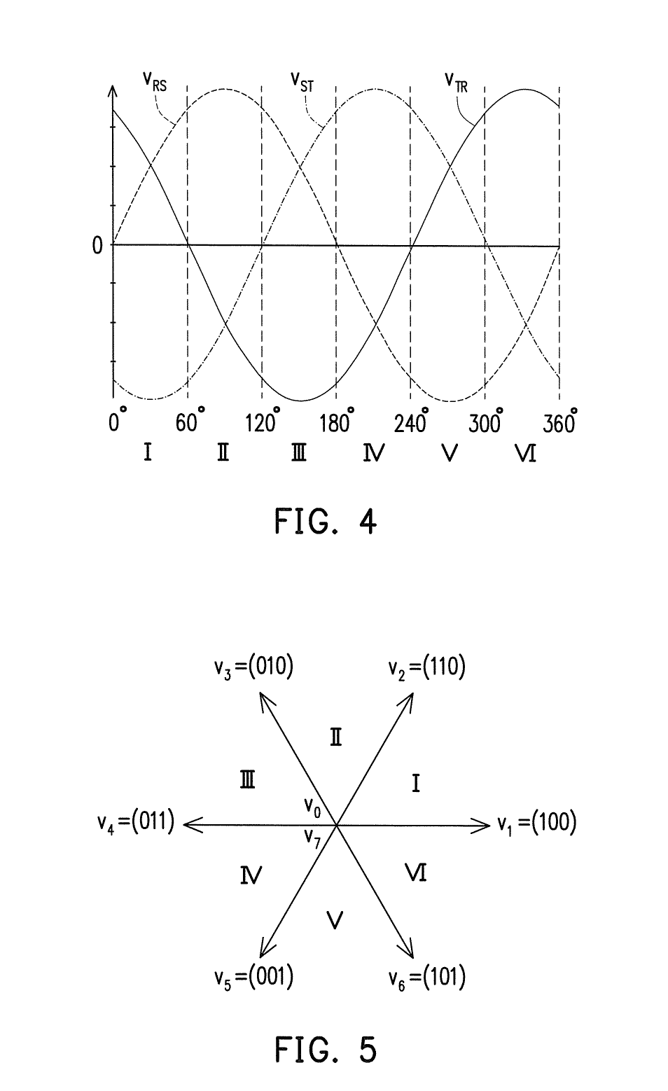

The aforementioned vector space will be further described with reference to FIG. 4 and FIG. 5 hereinafter. Referring to FIG. 4 first, FIG. 4 is a voltage waveform chart illustrating phase voltages v_{RS}, v_{ST}, v_{TR} of the three-phase system within a city power cycle (e.g., 60 or 50 Hz). Based on intersections of the phase voltages v_{RS}, v_{ST}, v_{TR} and the zero-voltage axis, phases in the vector space from 0 to 360 degrees may be divided into six phase intervals I to VI, which are from 0 to 60 degrees, from 60 to 120 degrees, from 120 to 180 degrees, from 180 to 240 degrees, from 240 to 300 degrees and from 300 to 360 degrees, respectively. FIG. 5 illustrates a vector space distribution map. According to FIG. 5, each of the intervals I to VI illustrated in FIG. 4 may be composed of two non-zero vectors (e.g., vectors V1 to V6) and a zero vector (e.g., V0, V7). Components of the non-zero vectors may be respectively served as control signals M1, M3, M5 of upper arms (e.g., the switches S1, S3, S5) of the switch sets S1 to S6 or the lower arms (e.g., the switches S2, S4, S6) of the control signals M2, M4, M6. For example, when the vector V1=(1 0 0), the corresponding control signal M1 may be a high potential, and the control signals M3, M5 may be low potentials, such that the switch S1 is correspondingly turned on, while the switches S3, S5 are correspondingly turned off. Similarly, in scenarios where the vector V2=(1 1 0), the vector V3=(0 1 0), the vector V4=(0 1 1), the vector V5=(0 0 1), and the vector V6=(1 0 1), each of the control signals M1 to M6 may be determined as a high potential or a low potential depending on whether the vector component is 1 or 0, so as to control to turn on or off the switches S1 to S6.

In this way, the switch sets S1 to S6 are controlled to be turned on or off through the vector space distribution illustrated in FIG. 5 and by utilizing the non-zero vectors, so as to obtain the state-switching voltages u_{RS,x}, u_{RS,y}, u_{ST,x}, u_{ST,y} of each of the intervals I to VI, as shown in Table 1 below.

TABLE 1

| | | | |
|---|---|---|---|
| | | Vector | Formed |
| SVPWM | State-switching voltage | number | vector |

| Interval | u_{RS,x} | u_{ST,x} | u_{RS,y} | u_{ST,y} | x | y | Vx | Vy |
|---|---|---|---|---|---|---|---|---|
| I: 0° to 60° | v_{DC} | 0 | 0 | v_{DC} | 1 | 2 | V1 | V2 |
| II: 60° to 120° | 0 | v_{DC} | −v_{DC} | v_{DC} | 2 | 3 | V2 | V3 |
| III: 120° to | −v_{DC} | v_{DC} | −v_{DC} | 0 | 3 | 4 | V3 | V4 |
| 180° | | | | | | | | |
| IV: 180° to | −v_{DC} | 0 | 0 | −v_{DC} | 4 | 5 | V4 | V5 |
| 240° | | | | | | | | |
| V: 240° to 300° | 0 | −v_{DC} | v_{DC} | −v_{DC} | 5 | 6 | V5 | V6 |
| VI: 300° to | v_{DC} | −v_{DC} | v_{DC} | 0 | 6 | 1 | V6 | V1 |
| 360° | | | | | | | | |

| SVPWM | Duty ratio | | | | | |
|---|---|---|---|---|---|---|
| Interval | D_{RH} | D_{RL} | D_{SH} | D_{SL} | D_{TH} | D_{TL} |
| I: 0° to 60° | Dx + Dy + D₀ | 1 − D_{RH} | Dy + D₀ | 1 − D_{SH} | D₀ | 1 − D_{TH} |
| II: 60° to 120° | Dy + D₀ | 1 − D_{RH} | Dx + Dy + D₀ | 1 − D_{SH} | D₀ | 1 − D_{TH} |
| III: 120° to | D₀ | 1 − D_{RH} | Dx + Dy + D₀ | 1 − D_{SH} | Dy + D₀ | 1 − D_{TH} |
| 180° | | | | | | |
| IV: 180° to | D₀ | 1 − D_{RH} | Dy + D₀ | 1 − D_{SH} | Dx + Dy + D₀ | 1 − D_{TH} |
| 240° | | | | | | |
| V: 240° to 300° | Dy + D₀ | 1 − D_{RH} | D₀ | 1 − D_{SH} | Dx + Dy + D₀ | 1 − D_{TH} |
| VI: 300° to | Dx + Dy + D₀ | 1 − D_{RH} | D₀ | 1 − D_{SH} | Dy + D₀ | 1 − D_{TH} |
| 360° | | | | | | |

Therein, v_{DC} represents the voltage value of the DC terminal VDC of the three-phase current converter 310.

Thereby, the controller 330 may obtain a duty ratio Dx, Dy of the switching period T corresponding to the vectors Vx, Vy according to Equation (5) and serve the components of the vectors Vx, Vy respectively as the control signals for turning on or turning off the switch sets S1 to S6, so as to obtain the duty ratio of the switching period of a vector space modulation of the switch sets S1 to S6. Table 1 lists duty ratios D_{RH}, D_{SH}, D_{TH} of the switching period of the switches S1, S3, S5 and duty ratios D_{RL}, D_{SL}, D_{TL} of the switching period of the switches S2, S4, S6, whose values are represented by using Dx, Dy, D₀, where D₀=1−Dx−Dy.

It should be noted that each parameter listed in Table 1 may be adapted for a space vector pulse width modulation (SVPWM) technique and applicable to various modes, such as a parallel mode, a rectification mode, a power factor leading mode, and a power factor lagging mode, of the city power of the three-phase current converter 310. Scenarios of inductance variations have been put into consideration in the control method of the present embodiment, and therefore, the distortion issue that may encounter to the conventional power conversion method during the parallel mode of the city power can be avoided.

Additionally, the three-phase D-Σ control method provided in the present embodiment may be further applied to a two-phase modulation (TPM) and also applied to a TPM power factor leading mode, a TPM power factor lagging mode and a TPM rectification mode. Refer to Table 2 below for each parameter with respect to the TPM.

TABLE 2

| | |
|---|---|
| TPM | State-switching voltage |

| Interval | u_{RS,x} | u_{ST,x} | u_{RS,y} | u_{ST,y} |
|---|---|---|---|---|
| I: 0° to 60° | v_{DC} | −v_{DC} | v_{DC} | 0 |
| II: 60° to 120° | v_{DC} | 0 | 0 | v_{DC} |
| III: 120° to 180° | 0 | v_{DC} | −v_{DC} | v_{DC} |
| IV: 180° to 240° | −v_{DC} | v_{DC} | −v_{DC} | 0 |
| V: 240° to 300° | −v_{DC} | 0 | 0 | −v_{DC} |
| VI: 300° to 360° | 0 | −v_{DC} | v_{DC} | −v_{DC} |

| TPM | Duty ratio | | | | | |
|---|---|---|---|---|---|---|
| Interval | D_{RH} | D_{RL} | D_{SH} | D_{SL} | D_{TH} | D_{TL} |
| I: 0° to 60° | Dx + Dy | 1 − Dx − Dy | 0 | 1 | Dx | 1 − Dx |
| II: 60° to 120° | 1 | 0 | 1 − Dx | Dx | 1 − Dx − Dy | Dx + Dy |
| III: 120° to 180° | Dx | 1 − Dx | Dx + Dy | 1 − Dx − Dy | 0 | 1 |
| IV: 180° to 240° | 1 − Dx − Dy | Dx + Dy | 1 | 0 | 1 − Dx | Dx |
| V: 240° to 300° | 0 | 1 | Dx | 1 − Dx | Dx + Dy | 1 − Dx − Dy |
| VI: 300° to 360° | 1 − Dx | Dx | 1 − Dx − Dy | Dx + Dy | 1 | 0 |

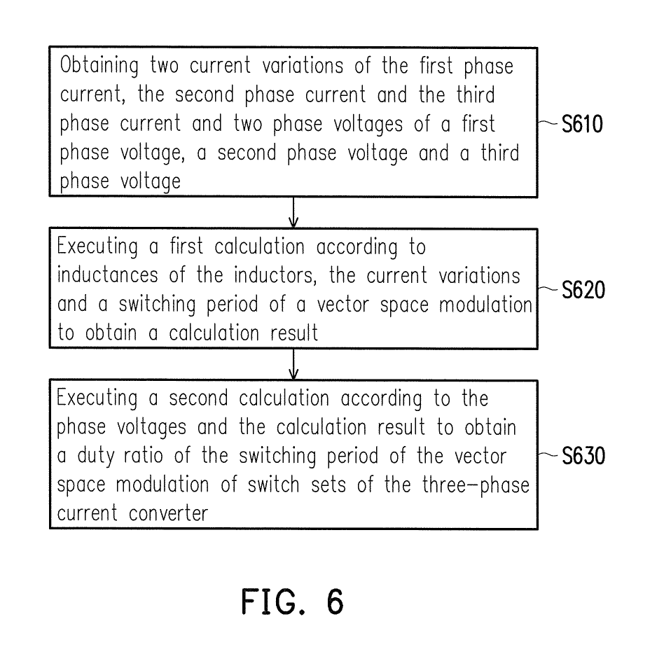

Thereby, based on the conversion relation obtained by Equation (5), a three-phase D-Σ control method of a three-phase current converter apparatus with varied inductances is provided according to the embodiments of the invention, of which a flowchart is illustrated in FIG. 6. The method of FIG. 6 is adapted for each element of the three-phase current converter apparatus 300 illustrated in FIG. 3. Steps of the control method performed by the controller 330 on the three-phase current converter 310 will be described with reference to FIG. 6 as follows.

First, in step S610, the controller 330 obtains two current variations of the phase currents IR, IS, IT and two phase voltages of the phase voltage v_{RS}, v_{ST}, V_{TR}. Therein, each current variation is a phase current variation of a switching period T, e.g., a current variation Δi_{R} of the phase current IR of a switching period T or a current variation Δi_{S} of the phase current IS of a switching period T.

Then, in step S620, the controller 330 executes a first calculation according to inductances L_{R}, L_{S}, L_{T} of the inductors LR, LS, LT, the current variations (e.g., Δi_{R} or Δi_{S}) and the switching period T of a vector space modulation to obtain a calculation result. Specifically, the controller 330 calculates a plurality of cross voltages on the inductors LR, LS, LT by using the inductances L_{R}, L_{S}, L_{T} and the current variations Δi_{R}, Δi_{S} in a matrix manner to obtain a first matrix M1, which is expressed by Equation (6) as follows:

$$M 1 = {L}_{2 S} [ \begin{matrix}Δ {i}_{R} \\ Δ {i}_{S}\end{matrix} ] \qquad ( 6 )$$

Therein,

$${L}_{2 S} = [ \begin{matrix}{L}_{R} & - {L}_{S} \\ {L}_{T} & {L}_{S} + {L}_{T}\end{matrix} ] ,$$

and the inductances L_{R}, L_{S}, L_{T} respectively vary with the phase currents IR, IS, IT.

Further, the controller 330 calculates a product by multiplying the reciprocal of the switching period T with the first matrix M1 to obtain a calculation result R, which is a matrix and expressed by Equation (7) as follows:

$$R = \{ \frac{1}{T} {L}_{2 S} [ \begin{matrix}Δ {i}_{R} \\ Δ {i}_{S}\end{matrix} ] \} \qquad ( 7 )$$

Thereafter, in step S630, the controller 330 executes a second calculation according to the obtained phase voltages and the calculation result to obtain a duty ratio of the switching period T of the vector space modulation of the switch sets S1 to S6 of the three-phase current converter 310. In detail, the controller 330 obtains a plurality of state-switching voltages (e.g., u_{RS,x}, U_{RS,y}, U_{ST,x}, U_{ST,y}) corresponding to one interval in the vector space to obtain a second matrix M2, which is expressed by Equation (8) as follows:

$$M 2 = [ \begin{matrix}{u}_{RS , x} & {u}_{RS , y} \\ {u}_{ST , x} & {u}_{ST , y}\end{matrix} ] \qquad ( 8 )$$

Afterwards, the controller 330 calculates a sum of the phase voltages v_{RS}, v_{ST} and the calculation result R to obtain a third matrix M3, which is expressed by Equation (9) as follows:

$$M 3 = \{ \frac{1}{T} {L}_{2 S} [ \begin{matrix}Δ {i}_{R} \\ Δ {i}_{S}\end{matrix} ] + [ \begin{matrix}{v}_{RS} \\ {v}_{ST}\end{matrix} ] \} \qquad ( 9 )$$

Then, the controller 330 calculates a product by multiplying the inverse matrix of the second matrix M2 with the third matrix M3 to obtain the duty ratio Dx, Dy of the switching period T corresponding to each vector in the Equation (5) and obtain the duty ratios D_{RH}, D_{RL}, D_{SH}, D_{SL}, D_{TH}, D_{TL} of the switching period T of the vector space modulation of the switch sets S1 to S6 corresponding to the modulation type by using each parameter listed in Table 1 (or Table 2) during the SVPWM mode or the TPM mode.

To conclude, in the three-phase current converter apparatus with varied inductances and the three-phase D-Σ control method thereof provided by the embodiments of the invention, the currents of the three-phase system are converted by using the state-switching voltages of the vector space with modulated pulses, so as to obtain the duty ratio of the switching period of the vector space modulation of a plurality of switch sets in the three-phase current converter. Thereby, the three-phase current converter apparatus and the control method can be adapted for scenarios where variations occur to the inductors to prevent the city power from being distorted and to simplify the conversion process.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A three-phase division-summation (D-Σ) control method of a three-phase current converter with varied inductance, wherein the three-phase current converter has a first inductor, a second inductor and a third inductor, and a first phase current, a second phase current and a third phase current respectively flow through the first inductor, the second inductor and the third inductor, the comprising:
obtaining two of a plurality of current variations of the first phase current, the second phase current and the third phase current and two of a plurality of phase voltages of a first phase voltage, a second phase voltage and a third phase voltage;
executing a first calculation according to a plurality of inductances of the inductors, the current variations and a switching period of a vector space modulation to obtain a calculation result; and
executing a second calculation according to the phase voltages and the calculation result to obtain a duty ratio of the switching period of the vector space modulation of a plurality of switch sets of the three-phase current converter,
wherein the inductances respectively vary with the first phase current, the second phase current and the third phase current.

2. The method according to claim 1, wherein the step of executing the first calculation according to the plurality of inductances of the inductors, the current variations and the switching period of the vector space modulation to obtain the calculation result further comprises:
calculating a plurality of cross voltages on the inductors by using the inductances and the current variations in a matrix manner to obtain a first matrix; and
calculating a product by multiplying the reciprocal of the switching period with the first matrix to obtain the calculation result.

3. The method according to claim 1, further comprising:
dividing the vector space into a plurality of intervals according to intersections of the first phase voltage, the second phase voltage and the third phase voltage of the three-phase current converter respectively intersecting with zero voltage, wherein each of the intervals is defined by two non-zero vectors and zero vector.

4. The method according to claim 3, wherein the step of executing the second calculation according to the phase voltages and the calculation result to obtain the duty ratio of the switching period of the vector space modulation of the plurality of switch sets of the three-phase current converter further comprises:
obtaining a plurality of state-switching voltages corresponding to one of the intervals in the vector space to obtain a second matrix;
calculating a sum of the phase voltages and the calculation result to obtain a third matrix; and
calculating a product by multiplying the inverse matrix of the second matrix with the third matrix to obtain the duty ratio of the switching period of the vector space modulation of the switch sets.

5. The method according to claim 1, wherein a relation of the inductances varying with the first phase current, the second phase current and the third phase current is recorded in a loop-up table, and the step of executing the first calculation according to the plurality of inductances of the inductors, the current variations and the switching period of the vector space modulation further comprises:
respectively obtaining the plurality of inductances by using the loop-up table according to the first phase current, the second phase current and the third phase current.

6. The method according to claim 1, wherein each of the current variations is a difference between a reference current and a detected current of the switching period.

7. A three-phase current converter apparatus with varied inductances, comprising:
a three-phase current converter, having a first inductor, a second inductor and a third inductor, wherein a first phase current, a second phase current and a third phase current respectively flow through the first inductor, the second inductor and the third inductor;
a driver circuit, coupled to the three-phase current converter to drive the three-phase current converter; and
a controller, coupled to the driver circuit to obtain two of a plurality of current variations of the first phase current, the second phase current and the third phase current and two of a plurality of phase voltages of a first phase voltage, a second phase voltage and a third phase voltage and configured to execute a first calculation according to a plurality of inductances of the inductors, the current variations and a switching period of a vector space modulation to obtain a calculation result and execute a second calculation according to the phase voltages and the calculation result to obtain a duty ratio of the switching period of the vector space modulation of a plurality of switch sets of the three-phase current converter,
wherein the inductances respectively vary with the first phase current, the second phase current and the third phase current.

8. The three-phase current converter apparatus according to claim 7, wherein the controller calculates a plurality of cross voltages on the inductors by using the inductances and the current variations in a matrix manner to obtain a first matrix and calculates a product by multiplying the reciprocal of the switching period with the first matrix to obtain the calculation result.

9. The three-phase current converter apparatus according to claim 7, wherein the controller further divides the vector space into a plurality of intervals according to intersections of the first phase voltage, the second phase voltage and the third phase voltage of the three-phase current converter respectively intersecting with zero voltage, wherein each of the intervals is defined by two non-zero vectors and zero vector.

10. The three-phase current converter apparatus according to claim 9, wherein the controller further obtains a plurality of state-switching voltages corresponding to one of the intervals in the vector space to obtain a second matrix, calculates a sum of the phase voltages and the calculation result to obtain a third matrix and calculates a product by multiplying the inverse matrix of the second matrix with the third matrix to obtain the duty ratio of the switching period of the vector space modulation of the switch sets.

11. The three-phase current converter apparatus according to claim 7 wherein a relation of the inductances varying with the first phase current, the second phase current and the third phase current is recorded in a loop-up table, and the controller further respectively obtains the plurality of inductances by using the loop-up table according to the first phase current, the second phase current and the third phase current.

12. The three-phase current converter apparatus according to claim 7, wherein each of the current variations is a difference between a reference current and a detected current of the switching period.
